(19) United States
(12) Patent Application Publication
(10) Pub. No.: US 2024/0264954 A1
(43) Pub. Date: Aug. 8, 2024

(54) MODULAR PERIPHERAL COMPUTING DEVICE INTERFACE AND HARDWARE ARCHITECTURE

(71) Applicant: MICROSOFT TECHNOLOGY LICENSING, LLC, Redmond, WA (US)

(72) Inventors: Adam SPIEGELMAN, Austin, TX (US); Kypros CONSTANTINIDES, Seattle, WA (US); Wilson V VU, Bellevue, WA (US); Shane Gerrard KAVANAGH, Austin, TX (US)

(21) Appl. No.: 18/165,132

(22) Filed: Feb. 6, 2023

(51) Int. Cl. G06F 13/10; G06F 1/26

(52) U.S. Cl. CPC G06F 13/102; G06F 1/266

(57) ABSTRACT

The disclosed techniques improve the functionality and efficiency of cloud computing systems by introducing a modular peripheral computing device interface and hardware architecture. Generally described, a host computing system such as a rack-mounted server is configured to interface with one or more peripheral computing devices of varying form factors through a peripheral device cartridge via a standardized connector interface. The peripheral device cartridge can comprise a receptacle configured to house one or more peripheral computing devices (e.g., GPUs, SSDs). Peripheral device cartridges can be inserted and/or removed from a front panel of the host computing system without requiring a full power down thereby preventing service disruptions. In addition, the modularity of the peripheral device cartridges enables changing device configurations on the fly regardless of device form factor. For example, a GPU can be quickly replaced with an SSD. Other technical benefits include dynamic power scaling and improved cooling efficiency.

### BACKGROUND

As cloud computing gains popularity, more and more data and/or services are stored and/or provided online via network connections. Providing an optimal and reliable user experience is an important aspect for cloud-based platforms that offer network services. In many scenarios, a cloud-based platform may provide a service to thousands or millions of users (e.g., customers, clients, tenants, etc.) geographically dispersed around a country, or even the world. In order to provide this service, a cloud-based platform often includes different computing resources, such as virtual machines or physical machines which are implemented in server farms deployed at various datacenters. Organizationally, these datacenters often contain many compute nodes which refer to individual hardware systems such as a rack-mounted server.

As is typical of a hardware system, each node can contain fundamental components such as a central processing unit (CPU) and memory (e.g., RAM). In addition, a hardware system can be optionally configured with various peripheral computing devices such as graphics processing units (GPUs), solid-state drives (SSDs) and/or hard disk drives (HDDs) for storage, field programmable gate arrays (FPGAs) and so forth. These peripheral devices can enable the hardware system to perform specialized functions such as enterprise computing, high-capacity network storage, media streaming, and the like. Stated another way, peripheral devices enable cloud platform providers to meet functional and performance demands.

Accordingly, as demand for functionality and performance grows these peripheral devices grow increasingly diverse. For example, a hardware system can be configured with specialized accelerators for machine learning, video transcoding, real-time cloud gaming, and so on. Consequently, increasing device diversity requires flexibility on the part of cloud platform providers to support various physical form factor requirements from existing standards such as full-height full-length (FHFL) cards and E1.S SSDs to unorthodox custom form factors. Moreover, different peripheral computing devices can also impose differing power requirements from twenty watts for a small expansion card up to and exceeding four hundred watts for a high-performance GPU.

Intuitively, this device diversity translates to many technical challenges when designing hardware systems. Oftentimes, in order to support a particular peripheral device type, a cloud platform provider must implement specialized server designs that lack flexibility and require extensive modifications to change device configurations (e.g., replacing an SSD with a GPU). In addition, these existing approaches to hardware system design can lead to complications with subsequent service and upgrade procedures.

For example, peripheral devices in a conventional hardware system are typically installed internally. That is, the hardware system must be powered down and dismantled in order to access the peripheral devices. In the event of a device failure or even regular maintenance, various computing services provided by the hardware system must be halted leading to extended downtime, reduced efficiency and service quality, and ultimately, a degraded user experience. Furthermore, the complexity of working with these hardware architectures increases the risk for error both human and otherwise. Additional challenges arise when device configurations and/or requirements change after a hardware system has been designed and deployed. For example, a new standard is released, technical and/or business needs change, and so forth.

It is with respect to these and other considerations that the disclosure made herein is presented.

### SUMMARY

The disclosed techniques improve the functionality and efficiency of cloud computing systems by introducing a modular peripheral computing device interface and hardware architecture. Generally described, a host computing system such as a rack-mounted server is configured to interface with one or more peripheral computing devices through a peripheral device cartridge via a standardized connector interface. The peripheral device cartridge can comprise a receptacle configured to house one or more peripheral computing devices. For example, a first peripheral device cartridge can be a single-width cartridge configured to house one single-width device such as an accelerator. In contrast, a second peripheral device cartridge can be a quad-width cartridge configured to house two interlinked double-width graphics processing units (GPUs).

In addition, the peripheral device cartridge can include a first standardized connector between the one or more peripheral computing devices and the receptacle. The first standardized connector can serve as the interface between the peripheral computing device and the host computing system and may utilize various standards such as Peripheral Component Interconnect Express (PCIe). In addition, the first standardized connector can provide power to the peripheral computing device in accordance with existing standards and/or custom implementations. It should be understood that the first standardized connector can utilize any suitable connection hardware such as high-speed backplane connectors and the like.

The peripheral device cartridge can further include a second standardized connector between the one or more peripheral computing devices and the receptacle for providing auxiliary power to the one or more peripheral computing devices. While the first standardized connector can provide power, some peripheral computing devices may require additional power to function properly. For example, a high-performance GPU utilizing the PCIe standard often impose high power requirements (e.g., hundreds of watts). Accordingly, the high-performance GPU can draw power from both the first and second standardized connectors within the peripheral device cartridge to meet this power requirement. In another example, some peripheral computing devices may dynamically scale power draw up and down based on computing demand and other factors. In response, changing power requirements, the peripheral device cartridge can dynamically modify the power delivered through the first and/or the second standardized connector.

For security and structural integrity, the peripheral device cartridge can also include a latch mechanism that secures the peripheral device cartridge to a peripheral device enclosure in the host computing system. Naturally, while the latch mechanism is engaged the peripheral device cartridge cannot be removed from the host computing system. In addition, as will be elaborated upon below, the latch mechanism can be coupled to an intrusion detection bar of the host computing system to further enhance security. In various examples, the latch mechanism can be a mechanical device comprising a catch and lever that physically secures the peripheral device cartridge to the host computing system.

To support the modular functionality of the peripheral computing device cartridges, the host computing system must be architected differently than typical computing systems. As mentioned above, a typical computing system houses peripheral devices internally near core components such as the central processing unit (CPU) and memory. In contrast, the host computing system disclosed herein can be comprised of a fundamental hardware platform including a motherboard module which houses the core components (e.g., a CPU coupled to a memory system). In addition, the host computing system can include an interface between the motherboard module and the peripheral device enclosure which houses the peripheral device cartridges. In various examples, the interface couples to the first standardized connector of the peripheral device cartridge discussed above. It should be understood that, like the first standardized connector, this interface can utilize any suitable connector hardware that is compatible with the first standardized connector.

By organizing a server device in this way, the disclosed techniques address many technical challenges associated with modern server design and enable several technical benefits over existing approaches. For example, in this hardware architecture, the peripheral devices are readily accessible from a front panel of the server device. Consequently, peripheral devices can be quickly added, removed, and/or replaced without disconnecting the server device from a larger system (e.g., a datacenter rack). In this way, peripheral computing devices can be “hot swapped” without powering down the server thereby reducing service disruptions. Furthermore, the modular nature of this hardware architecture streamlines subsequent maintenance and upgrade processes. For instance, a technician can simply remove and replace peripheral device cartridges with minimal intrusion on server device further reducing and even eliminating service disruptions.

In another example of the technical benefit of the present disclosure, the modular hardware architecture enables a common hardware platform that supports many device configurations. For example, a first configuration can be a combination of single-width peripheral device cartridges housing single-width GPUs and solid-state drives (SSDs). Conversely, a second configuration can include quad-width peripheral device cartridges housing interconnected double-width GPUs paired with single-width peripheral device cartridges for SSDs. Both configurations can utilize the same fundamental hardware platform (e.g., CPU, RAM). In this way, the proposed hardware architecture can reduce the development costs associated with implementing new and/or different server designs.

Moreover, the modular peripheral device cartridges enable users to change device configurations over time according to technical needs with minimal effort. For example, an SSD peripheral device cartridge can be replaced with a GPU peripheral device cartridge without requiring access to the internals of the server device. Moreover, by masking the variability of peripheral computing devices using the peripheral device cartridge, the server device can isolate necessary changes to support new technologies and/or form factors to the peripheral device cartridges themselves. For instance, if a new form factor of peripheral computing device is released, a cloud platform provider can develop and/or source a new peripheral device cartridge without modifying the rest of the server device (e.g., the fundamental hardware platform). In this way, the techniques discussed herein dramatically reduce the time, complexity, and risk associated with operating server devices.

In still another example of the technical benefit of the present disclosure, by modularizing a server device into a host computing system and peripheral device cartridges, the proposed techniques enable thermal isolation of the host computing system from the peripheral computing devices thereby improving cooling and power efficiency. As will be shown and discussed below, the modular hardware architecture discussed herein enables a motherboard module containing the core components of the fundamental hardware platform (e.g., CPU, RAM) to reside in a separate thermal domain from the peripheral device enclosure. Consequently, each component of the server device can be cooled independently resulting in increased thermal efficiency translating into a reduced power draw associated with cooling.

Features and technical benefits other than those explicitly described above will be apparent from a reading of the following Detailed Description and a review of the associated drawings. This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithms, hardware logic, and/or operation(s) as permitted by the context described above and throughout the document.

### BRIEF DESCRIPTION OF THE DRAWINGS

The Detailed Description is described with reference to the accompanying figures. In the figures, the left-most digit(s) of a reference number identifies the figure in which the reference number first appears. The same reference numbers in different figures indicate similar or identical items. References made to individual items of a plurality of items can use a reference number with a letter of a sequence of letters to refer to each individual item. Generic references to the items may use the specific reference number without the sequence of letters.

FIG. 1 illustrates a server device comprising a host computing system and a plurality of modular peripheral device cartridges.

FIG. 2 is a block diagram illustrating aspects of the server device comprising a host computing system and a plurality of peripheral device cartridges.

FIG. 3 illustrates an example of a modular peripheral computing device cartridge.

FIG. 4A illustrates a first example device configuration for a server device with modular peripheral device cartridges.

FIG. 4B illustrates a second example device configuration for a server device with modular peripheral device cartridges.

FIG. 4C illustrates a third example device configuration for a server device with modular peripheral device cartridges.

FIG. 5A illustrates a first cooling solution comprising independent thermal domains for components of the server device.

FIG. 5B illustrates a second cooling solution comprising independent thermal domains for components of the server device.

FIG. 6 is a flow diagram showing aspects of a routine for implementing a peripheral device cartridge configured to interface one or more peripheral computing devices to a host computing system.

FIG. 7 is a flow diagram showing aspects of a routine for implementing a host computing device configured to interface with one or more peripheral computing devices through a peripheral device cartridge.

FIGS. 8A and 8B illustrate a flow diagram showing aspects of a routine for implementing a server device comprising a host computing device and a plurality of peripheral device cartridges.

### DETAILED DESCRIPTION

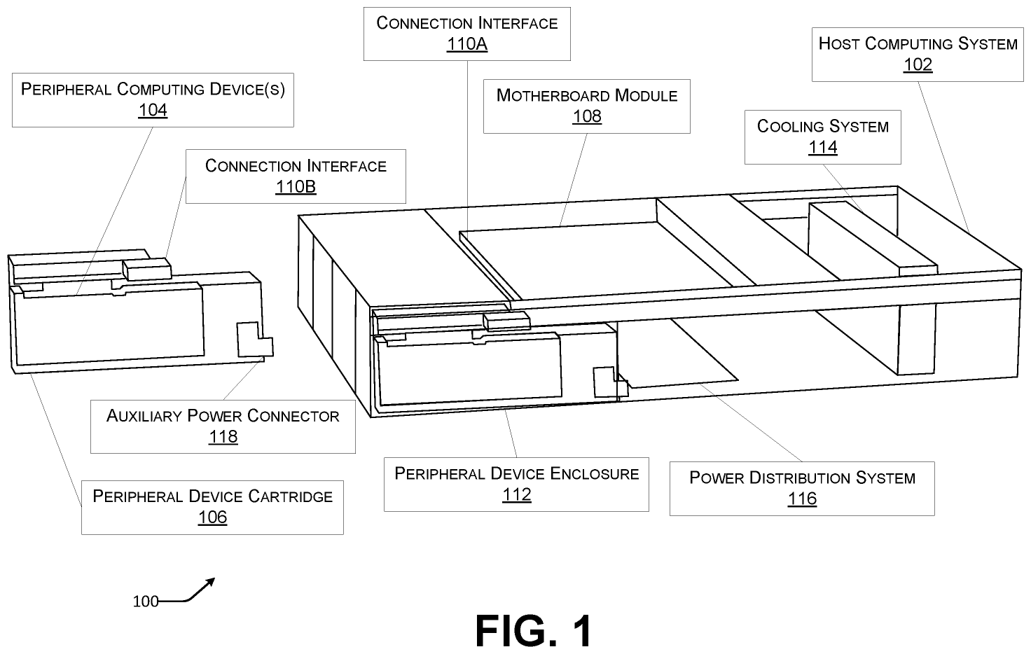

FIG. 1 illustrates a server device 100 comprising a host computing system 102 that is configured to interface with a peripheral computing device 104 through a peripheral device cartridge 106. In various examples, the host computing system 102 can be a rack mounted server that forms a portion of a larger system (e.g., a datacenter). As mentioned above, the host computing system 102 can include a fundamental hardware platform. The fundamental hardware platform can comprise components of the server device 100 which can be utilized irrespective of the configuration of peripheral computing devices 104. For instance, the fundamental hardware platform can include a motherboard module 108 which contains core components of the host computing system 102 such as a central processing unit (CPU) and a memory system (e.g., RAM). The fundamental hardware platform may also include a connection interface 110A that can be coupled to the motherboard module 108 to interface with the peripheral device cartridges 106 in the peripheral device enclosure 112. Furthermore, the fundamental hardware platform can include cooling system 114 as well as a power distribution system 116.

As shown in FIG. 1, the peripheral device enclosure 112 can support a plurality of peripheral device cartridges 106 housing one or more peripheral computing devices 104. As discussed above and elaborated upon below, the peripheral computing devices 104 can be any suitable computing device for fulfilling a selected function of the server device 100. For instance, a server device 100 that is a designated storage server can be configured with peripheral device cartridges 106 that contain solid-state drives (SSDs). Conversely, a server device 100 that is intended for machine learning applications can be configured with peripheral device cartridges 106 that house graphics processing units (GPUs) as well as SSDs.

The peripheral device cartridge 106 can also include a connection interface 110B which, when attached to the connection interface 110A at the motherboard module 108 enables the peripheral computing device to interact with the host computing system 102. In addition to the connection interface 110B, the peripheral device cartridge 104 can include an auxiliary power connector 118. The auxiliary power connector 118 can attach to the power distribution system 116 in the host computing system 102. As mentioned above, while the peripheral computing devices 104 can draw power through the connection interface 110A and 110B, fluctuating power demands and/or particularly powerful peripheral computing devices 104 may require additional power which can be provided via the auxiliary power connector.

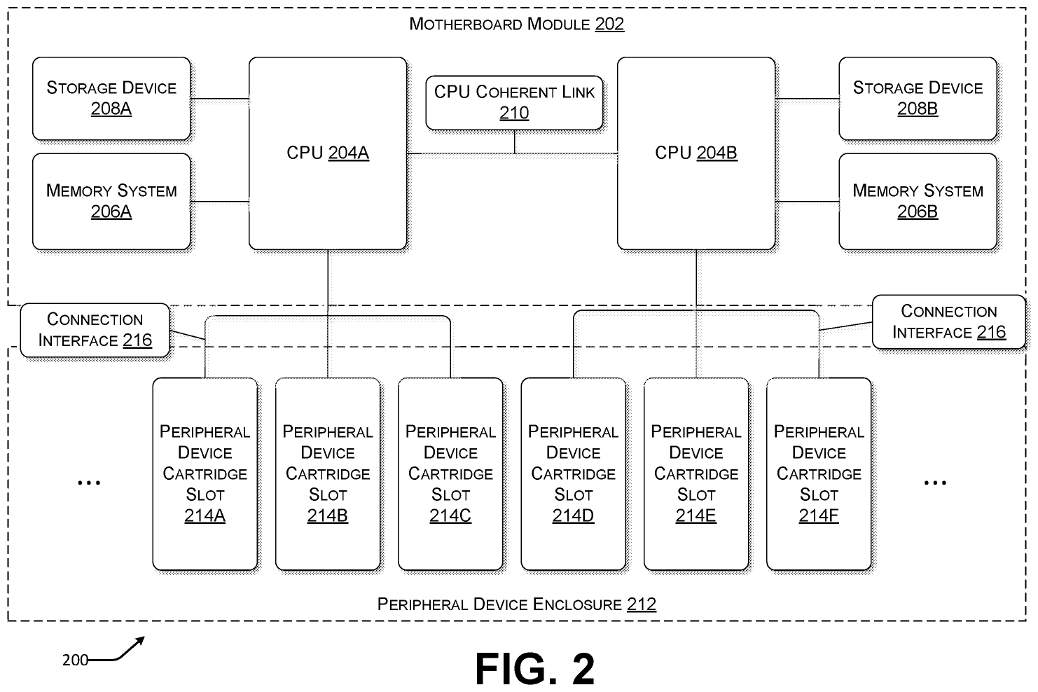

Turning now to FIG. 2, aspects of a host computing system 200 configured to interface with peripheral computing devices are shown and described. As discussed above, a host computing system 200 can include a fundamental hardware platform containing a motherboard module 202. The motherboard module 202 can include essential computing components that form the foundation of the host computing system 200 irrespective of peripheral device configuration, intended use case, and so forth. For instance, the motherboard module 202 can be a dual socket motherboard to support multiple CPUs 204A and 204B. Accordingly, each CPU 204A and 204B can be coupled to a corresponding memory system 206A and 206B as well as a storage device 208A and 208B to enable all basic computing functionality. It should be noted that the storage devices 208A and 208B can be different from and are distinct from SSDs in a peripheral device cartridge such as the ones described above. In various examples, the storage devices 208A and 208B store essential programs for operating the host computing system 200 such as an operating system, management programs, and so forth. Accordingly, the storage devices 208A and 208B may be inaccessible by external users (e.g., customers, tenants).

Furthermore, the CPUs 204A and 204B can themselves be coupled via a CPU coherent link 210. The CPU coherent link 210 can serve to orchestrate the functions of the CPUs 204A and 204B to operate as a single unit. Similarly, the CPU coherent link can accordingly orchestrate the memory systems 206A and 206B and the storage devices 208A and 208B. In this way, the CPU coherent link simplifies operations for peripheral devices connected to the host computing system 200 while providing access to abundant computing resources.

In addition to the motherboard module 202, the host computing system 200 can include a peripheral device enclosure 212 comprising a plurality of peripheral device cartridge slots 214A-214F. As discussed above, the peripheral device cartridge slots 214 can connect to the CPUs 204 at the motherboard module 202 via a high-speed connection interface 216. The connection interface 216 can be a plurality of hardware connection components (e.g., high-speed backplane connectors). In various examples, the peripheral device cartridge slots 214 can vary in size to support different types of peripheral device cartridges. For instance, one peripheral device cartridge slot 214A can be a single-width slot while another peripheral device cartridge slot 214B may be a quad-width slot. Moreover, smaller peripheral device cartridges can be placed in larger peripheral device cartridge slots 214B.

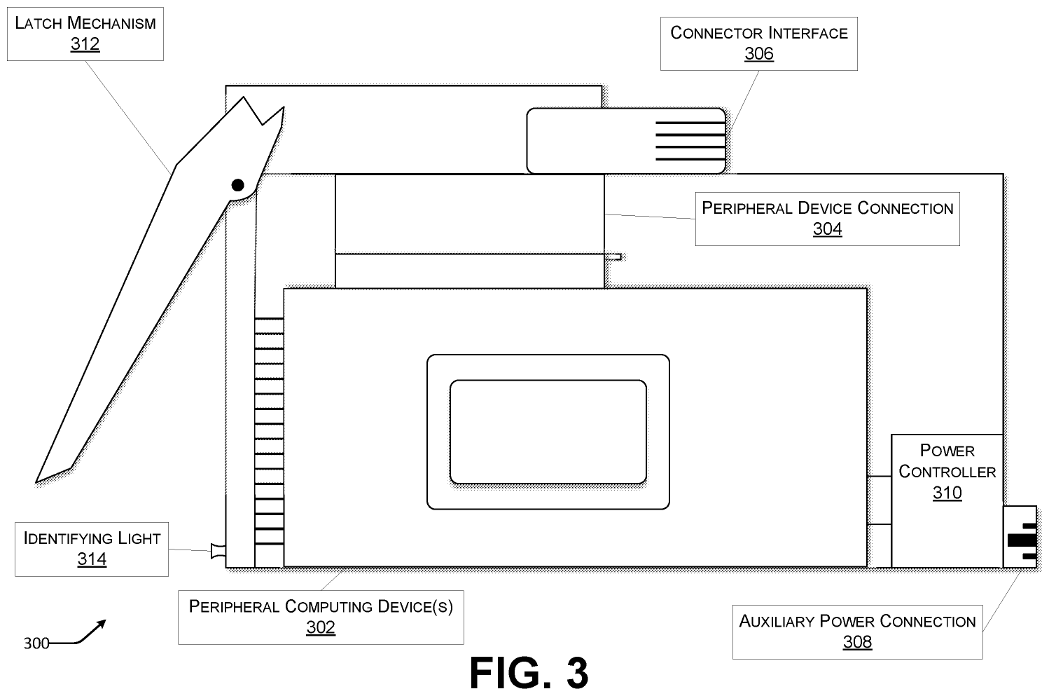

Proceeding to FIG. 3, aspects of a peripheral device cartridge 300 are shown and described. As described above, a peripheral device cartridge 300 can be configured to house one or more peripheral computing devices 302. For example, the peripheral device cartridge 300 can be configured to hold a GPU. Alternatively, the peripheral device cartridge 300 can be configured to hold four SSDs. Within the peripheral device cartridge 300, the peripheral computing device 302 can attach via a peripheral device connection 304.

The peripheral device connection 304 can serve as a passthrough to the connector interface 306. In this way, the peripheral device connection and the connector interface 306 can serve to mask variability in peripheral computing devices. Stated another way, the peripheral device connection 304 and the connector interface 306 can form a standardized connector for interfacing the peripheral computing device 302 with a host computing system. In addition, the peripheral device connection 304 can be customized to support different peripheral computing devices 302. For example, the peripheral device connection 304 for a GPU can be different from the peripheral device connection 304 for an SSD.

The connector interface 306 can utilize any suitable connection hardware such as high-speed backplane board-to-board connectors and the like that is the same for each peripheral device cartridge 300 irrespective of the peripheral computing device within thereby forming a standardized connector. In this way, while individual peripheral computing devices 302 may require different peripheral device connections 304 and impose varying size and power requirements, this variability can be masked by the peripheral device cartridge 300 through a standardized connector (e.g., the connector interface 306).

Furthermore, the peripheral device cartridge 300 can include an auxiliary power connection 308 forming a standardized connection to a power distribution system to augment power provided by the peripheral device connection 304 and connector interface 306. As discussed above, power requirements for different peripheral computing devices 302 can vary widely from a few watts to hundreds of watts. Moreover, these power requirements may not be static with some peripheral computing devices 302 such as GPUs dynamically modifying their power draw based on load. Accordingly, the peripheral device cartridge 300 can adjust power delivery in kind both through the peripheral device connection 304 and/or the auxiliary power connection 308 via a power controller 310. In an illustrative example, the peripheral computing device 302 can be a high-performance GPU that is currently idle. In response, the power controller 310 can reduce and/or disable power delivery through the auxiliary power connection 308 and provide all necessary power through the peripheral device connection 304. Subsequently, as the peripheral computing device 302 ramps up performance in response to a computing task, the power controller 310 can respond by increasing power delivery through the auxiliary power connection 308.

As illustrated in FIG. 3, the peripheral device cartridge 300 can further comprise a latch mechanism 312 which serves to physically secure the peripheral device cartridge 300 to the host computing system. When engaged, the latch mechanism 312 can prevent the peripheral device cartridge from being removed from the host computing system. As will be discussed further below, the latch mechanism 312 can be coupled to a control module to generate an alert when the latch mechanism 312 is disengaged during live operation (e.g., a hot swap). In addition, the peripheral device cartridge 300 can include an identifying light 314 to indicate the current operational status of the peripheral computing device 302 (e.g., online, offline). In some examples, the identifying light 314 can be incorporated into the latch mechanism 312 or other suitably visible locations on the peripheral device cartridge 300. The identifying light 314 can utilize any suitable light-emitting device such as a light-emitting diode (LED). In various examples, the latch mechanism can be a mechanical device comprising a catch and lever that physically secures the peripheral device cartridge to the host computing system.

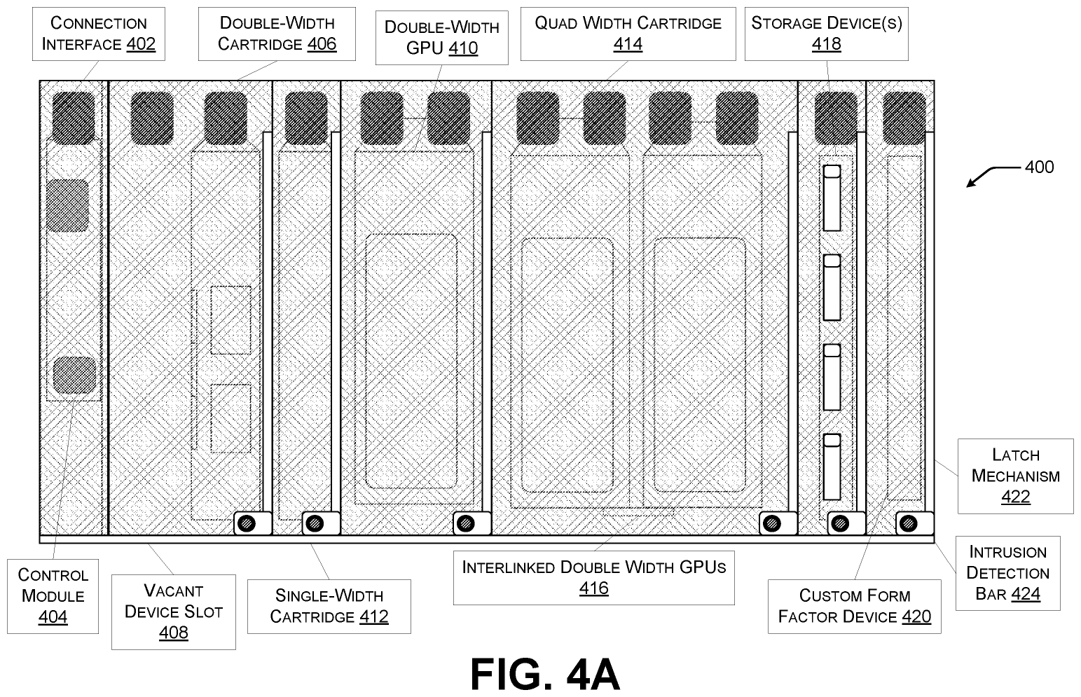

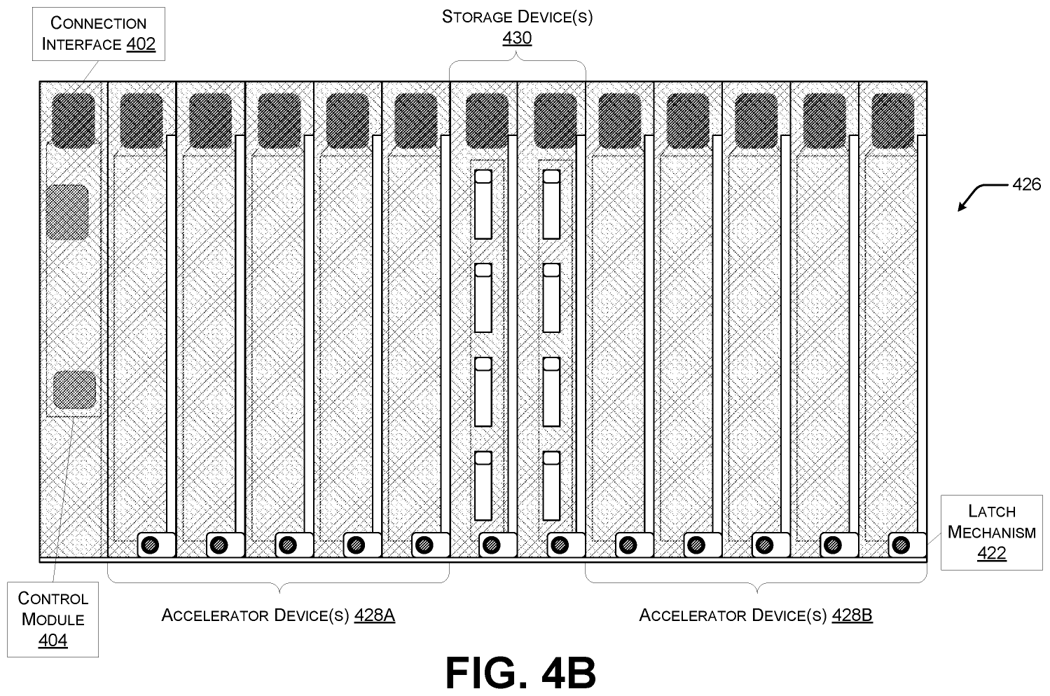

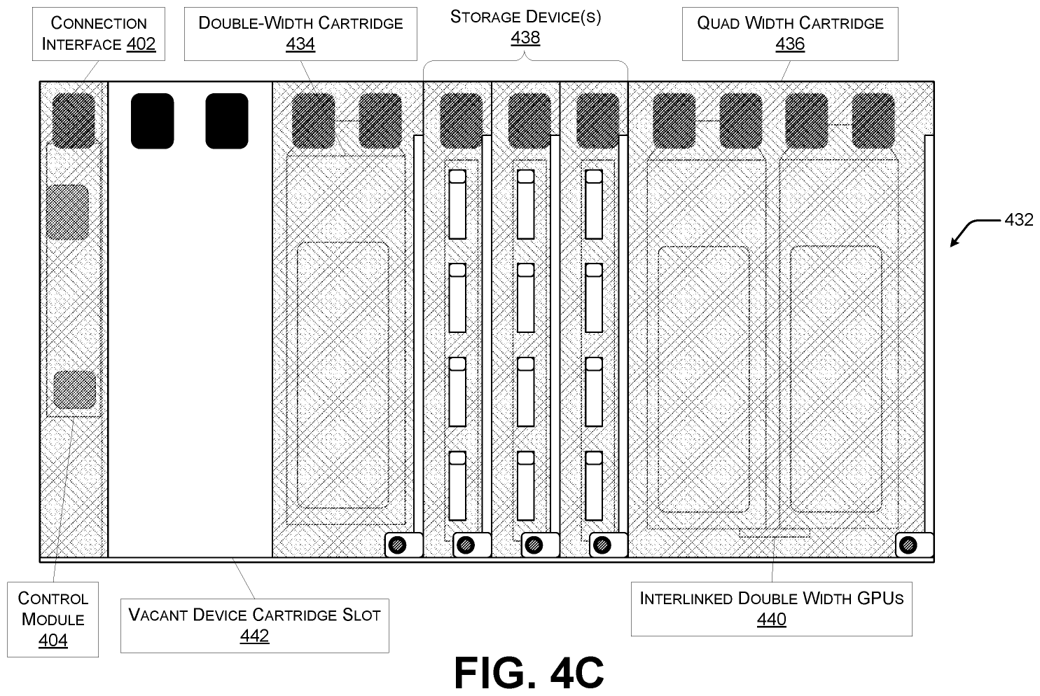

Turning now to FIG. 4A, an example device configuration 400 in a peripheral device enclosure is shown and described. The illustration of FIG. 4A is a front panel perspective of the peripheral device enclosure where peripheral device cartridges are inserted. As discussed above, the modular hardware architecture of the server device enables a host computing system to support device configurations comprising many disparate peripheral computing devices through a standardized connection interface 302. For example, the device configuration 400 shown in FIG. 4A can include a control module 404 which can also be referred to as a baseboard management controller (BMC). The control module 404 can enable remote access to and control of the associated server device. For instance, the control module 404 can enable a system engineer or administrator to remotely install software and modify other aspects of the server device. In various examples, due to its crucial operational role, the control module 404, can be considered part of the fundamental hardware platform despite being connected as a peripheral device.

As shown, peripheral device cartridges can vary in size to support different peripheral computing device form factors as well as multiple devices. For example, a double-width cartridge 406 can house one single-width device while optionally leaving a vacant device slot 408 for future expandability. Conversely, a double-width cartridge 408 can be configured to hold one double-width GPU 410. In addition, the device configuration 400 can include single width cartridges 412 for housing individual devices such as the control module 404. Moreover, the device configuration can further comprise a quad-width cartridge 414 which can be configured to hold multiple large devices. For example, some resource intensive computing applications such as machine learning benefit from interlinked double-width GPUs 416. Accordingly, to support such a device arrangement in a modularly, the device configuration 400 can include a quad-width cartridge 414.

Furthermore, single-width cartridges 412 can be customized to house different form factors as well as multiple devices. For example, as shown, a single-width cartridge can be configured to house four storage devices 418. In various examples, the storage devices 418 can be a standard form factor such as E1.S or E3.S also known as “rulers.” However, further extending the flexibility of the device configuration 400, a peripheral device cartridge can be configured to house a custom form factor device 420. In various examples, a custom form factor device 420 can be a peripheral computing device that does not adhere to common standards (e.g., E1.S, full-height full-length). Despite non-standard form factors, the changes that are required to support a custom form factor device 420 can be isolated to a peripheral device cartridge. That is, no changes are required to the host computing system or other peripheral device cartridges.

As mentioned above, each peripheral device cartridge can include a latch mechanism for physically securing the peripheral device cartridge to the peripheral device enclosure. In addition, the latch mechanism 422 can attach to an intrusion detection bar 424 spanning the width of the peripheral device enclosure. In various examples, the intrusion detection bar 424 can include a chassis intrusion circuit which notifies the control module 404 in the event any of the device cartridges are removed. Since the latch mechanism 422 for each device cartridge is coupled to the intrusion detection bar 424, the intrusion detection bar 424 must be unlocked in order to remove a peripheral device cartridge thereby triggering the chassis intrusion circuit. In response, the chassis intrusion circuit generates an intrusion event which is recorded by the control module 404. In this way, the server device can detect any changes in the device configuration 400. Moreover, in the event of unauthorized device removal (e.g., theft) the intrusion detection bar 424 can provide detectability and traceability.

Turning now to FIG. 4B, a second example of a device configuration 426 is shown and described. As mentioned above, the selection of peripheral devices for the device configuration 426 can be based on an intended task for the server device. For example, a user may wish to construct a server device for performing specialized computing tasks such as video transcoding. Accordingly, the device configuration 426 can comprise banks of accelerator devices 428A and 428B and a bank of storage devices 430. In various examples, the accelerator devices 428A and 428B can be a standard form factor such as E1.S. Conversely, the accelerator devices 428A and 428B may be a non-standard custom form factor. However, due to the standardized connection interface 402, the peripheral device cartridges can support the accelerator devices 428A and 428B irrespective of form factor, connection type, power requirement and the like. As with the device configuration 400 discussed above, the present device configuration 426 can include a control module 404 for system security and management as well as latch mechanisms 422 for physical security.

Proceeding now to FIG. 4C, a third device configuration 432 is shown and described. Similar to the device configuration 426 discussed above, the device configuration 432 can be designed for executing specialized computing tasks. In the present example, the device configuration 432 can comprise double-width cartridges 434 and/or quad-width cartridges 436 housing GPUs paired with a set of storage devices 438 for performing machine learning tasks. For instance, a quad-width cartridge can hold two interlinked double-width GPUs 440 while a double-width cartridge 434 can hold a single double-width GPU. While not illustrated, the device configuration 432 can further comprise single-width device cartridges and/or single-width peripheral computing devices. Furthermore, depending on technical needs, cost considerations, and other factors, the device configuration 432 can contain a vacant device cartridge slot 442. It should be understood that all the example device configurations 400, 426, and 432 can be implemented using the same host computing system. That is, by removing and replacing peripheral device cartridges can enable broad functionality without any modifications to the fundamental hardware platform.

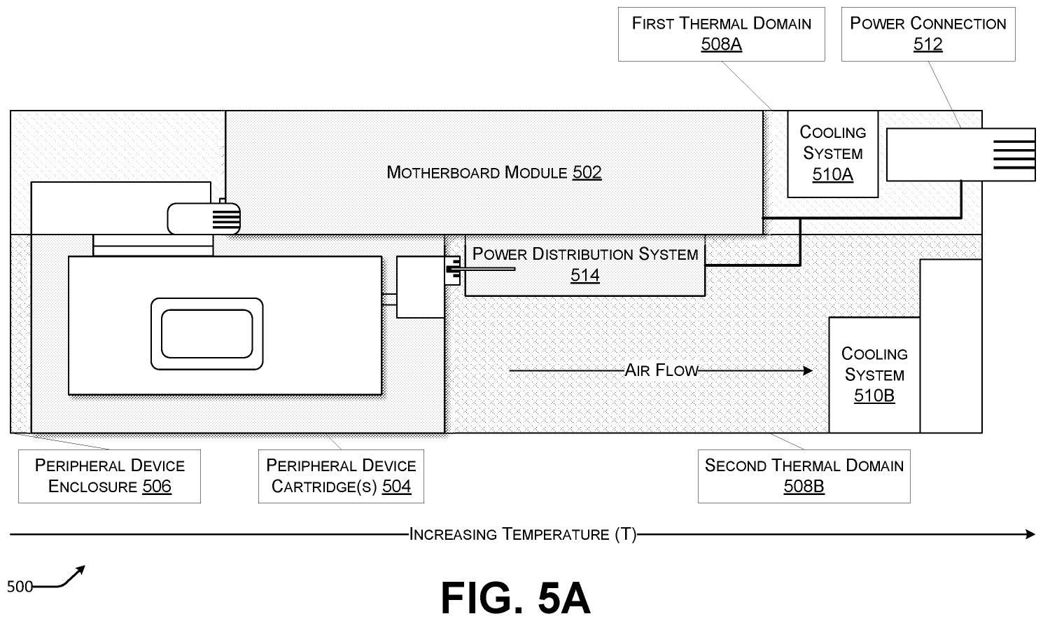

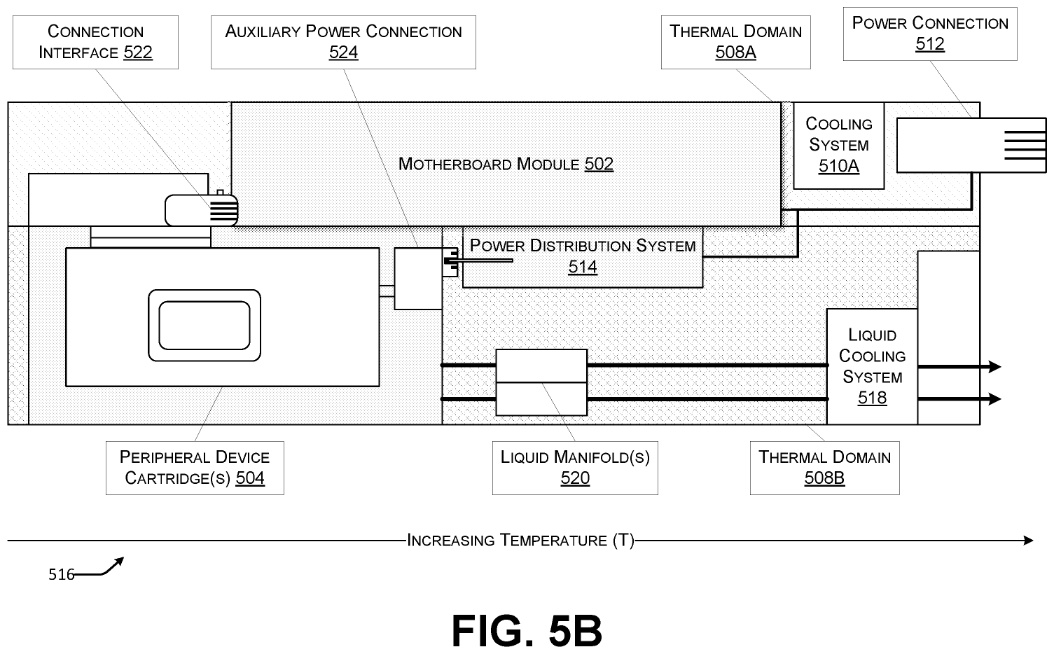

Turning now to FIG. 5A, an example of a server device 500 implementing a high-efficiency cooling solution is shown and described. As mentioned above, the modular hardware architecture of the present disclosure enables improved cooling through thermal isolation of the motherboard module 502 from the peripheral device cartridges 504 within the peripheral device enclosure 506. Stated alternatively, the motherboard module 502 can occupy a first thermal domain 508A while the peripheral device cartridges 504 occupy a second thermal domain 508B. Accordingly, each thermal domain 508A and 508B can be configured with a corresponding cooling system 510A and 510B respectively.

In various examples, implementing separate thermal domains 508A and 508B for the motherboard module 502 and the peripheral device cartridges 504 respectively can improve the cooling efficiency of the server device 500. For instance, cooling needs may differ for the first thermal domain 508A containing the motherboard module 502 and the second thermal domain 508B containing the peripheral device cartridges 504 at a given time. Accordingly, the cooling systems 510A and 510B can enabled, disabled, and/or adjusted based on various factors such as the current internal temperature, current external temperature, computing load, current component temperature, current device cartridge temperature, and the like.

The cooling systems 510A and 510B can include cooling components such as fans, temperature sensors, fan controllers, monitoring software and so forth. In addition, adjusting the cooling systems 510A and 510B can involve administrative activity such as manually changing fan speeds and/or modifying fan curves defining temperature thresholds at which fan speeds increase and/or decrease. Furthermore, the cooling systems 510A and 510B can be adjusted based on a current power draw via a power connection 512 of the server device 500 and/or a power distribution system 514 serving the peripheral device cartridges 504. For example, an elevated power draw by the peripheral device cartridges 504 from the power distribution system 514 can indicate an increased cooling requirement. In response the cooling system 510B can increase fan speeds to increase cooling within the second thermal domain 508B. As discussed above, the cooling systems 510A and 510B can be considered components of the fundamental hardware platform.

In another example, by orienting the peripheral device cartridges 504 at the front of the server device 500, the modular hardware architecture enables improved cooling for peripheral computing devices. Often referred to as the “cool side,” the front of the server device 500 is the where cool air enters as fans of the cooling systems 510A and 510B at the back of the server device draw in air as indicated by the “air flow” arrow. Consequently, a temperature gradient can exist within the server device 500 where a temperature (T) increases from the front to the back (aka the “hot side”) where hot air is expelled. By implementing separate thermal domains 508A and 508B, the peripheral device cartridges 504 can efficiently receive cool air without interference from other system components (e.g., the motherboard module 502). In this way, the server device 500 can reduce the power requirements to maintain acceptable operating temperatures. Alternatively, the increased cooling efficiency enabled by the server device 500 can enable increased device performance for a given cooling power.

Turning now to FIG. 5B, another example of a server device 516 implementing separate thermal domains 508A and 508B for the motherboard module 502 and the peripheral device cartridges 504 is shown and described. As shown, the first thermal domain 508A can be served by a cooling system 510A like in the example discussed above. However, unlike the previous example, the second thermal domain can be optionally configured with a liquid cooling system 518. The peripheral device cartridges 504 can interface with the liquid cooling system 518 via one or more liquid manifolds 520. For instance, a first liquid manifold 520 can bring cool liquid to the peripheral device while a second liquid manifold 520 carries hot liquid away.

In various examples, the liquid manifold 520 can be a “blind mate” liquid manifold 520 meaning that by simply inserting the peripheral device cartridge 504, a connection is established between the peripheral device cartridge 504 and the liquid manifold 520. As discussed above, the connection interface 522 can be understood as forming a first standardized connection of the peripheral device cartridge 504. Similarly, the auxiliary power connection 524 can be considered a second standardized connection. In this vein, the liquid manifold can be considered a third standardized connection like the connection interface 522 and the auxiliary power connection 524.

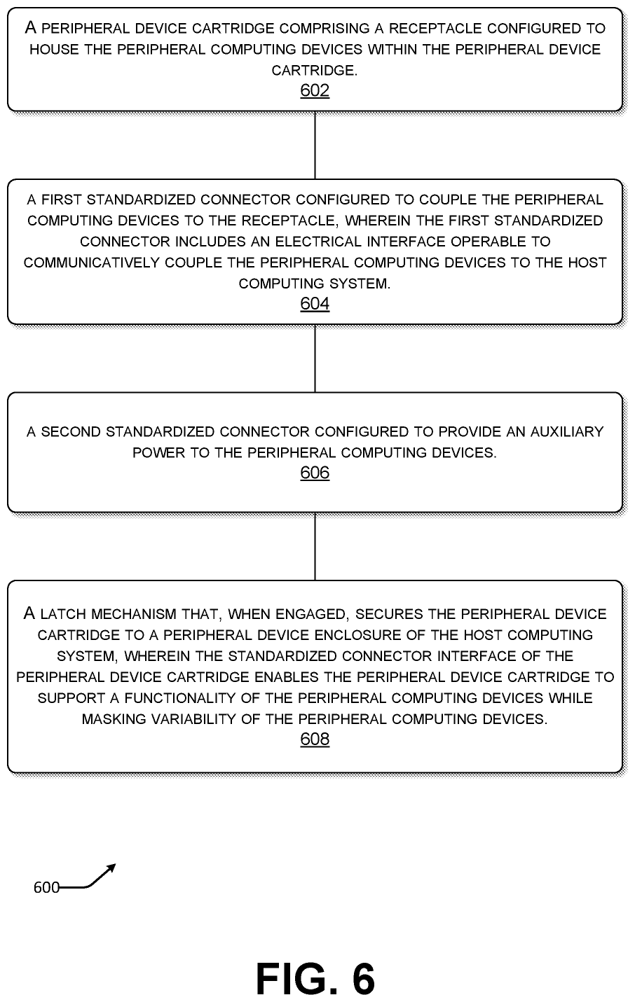

Turning now to FIG. 6, aspects of a routine 600 for implementing a peripheral device cartridge that is configured to interface one or more peripheral computing devices to a host computing device through a standardized connector interface are shown and described. With reference to FIG. 6, the routine 600 begins at operation 602 in which the peripheral device cartridge is constructed with a receptacle configured to house the one or more peripheral computing devices within the peripheral device cartridge.

Next, at operation 604, the peripheral device cartridge is configured with a first standardized connector between the one or more peripheral computing devices and the receptacle for interfacing the one or more peripheral computing devices to the host computing system.

Then, at operation 606, the peripheral device cartridge is configured with a second standardized connector between the one or more peripheral computing devices and the receptacle for providing an auxiliary power to the one or more peripheral computing devices.

Finally, at operation 608, the peripheral device cartridge is configured with a latch mechanism that, when engaged, secures the peripheral device cartridge to a peripheral device enclosure of the host computing system, wherein the standardized connector interface of the peripheral device cartridge masks a variability of the one or more peripheral computing devices.

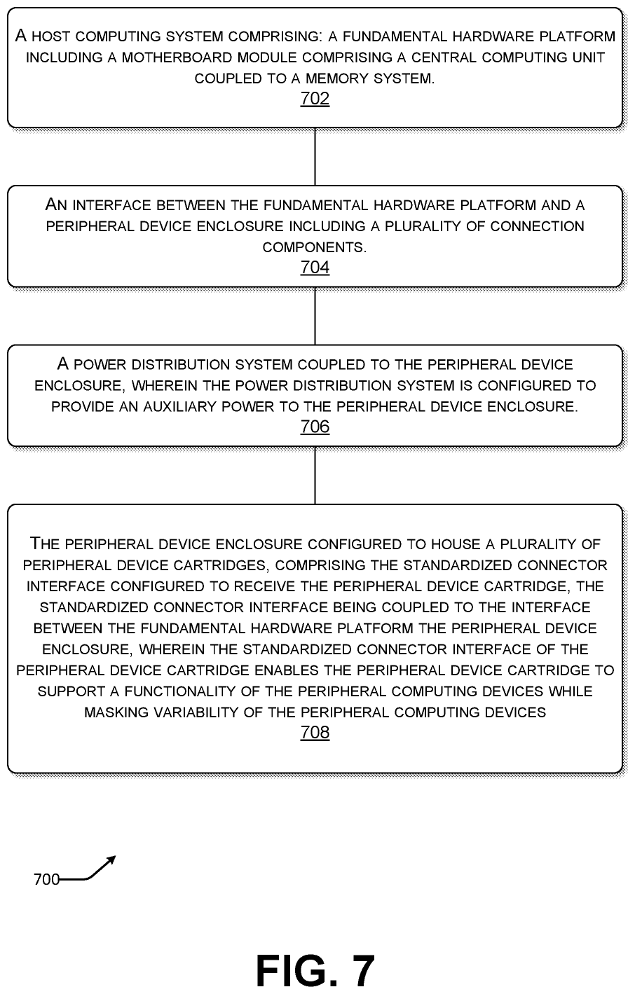

Proceeding to FIG. 7, aspects of a routine 700 for implementing a host computing system configured to interface with one or more peripheral computing devices through a peripheral device cartridge via a standardized connector interface is shown and described. With reference to FIG. 7, the routine 700 begins at operation 702 in which the host computing system is constructed with a fundamental hardware platform including a motherboard module comprising a central computing unit coupled to a memory system.

Next, at operation 704, the host computing system is configured with an interface between the fundamental hardware platform and a peripheral device enclosure including a plurality of connection components.

Then, at operation 706, the host computing system is configured with a power distribution system coupled to the peripheral device enclosure to provide an auxiliary power to the peripheral device enclosure.

Finally at operation 708, the host computing system is configured with the peripheral device enclosure for housing a plurality of peripheral device cartridges, comprising the standardized connector interface configured to receive the peripheral device cartridge, the standardized connector interface being coupled to the interface between the fundamental hardware platform the peripheral device enclosure, wherein the standardized connector interface of the peripheral device cartridge masks a variability of the one or more peripheral computing devices.

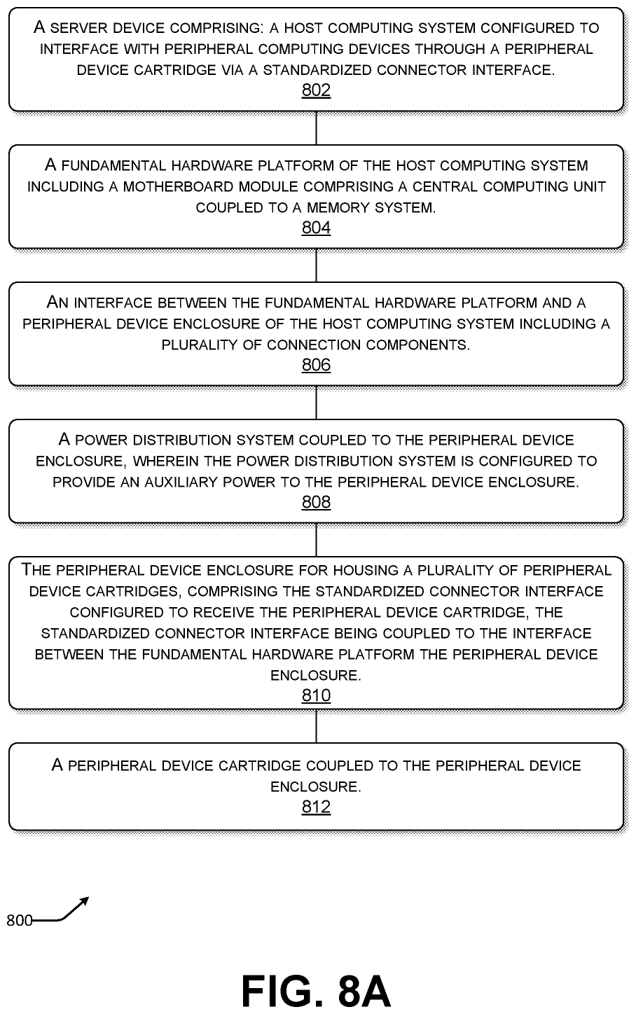

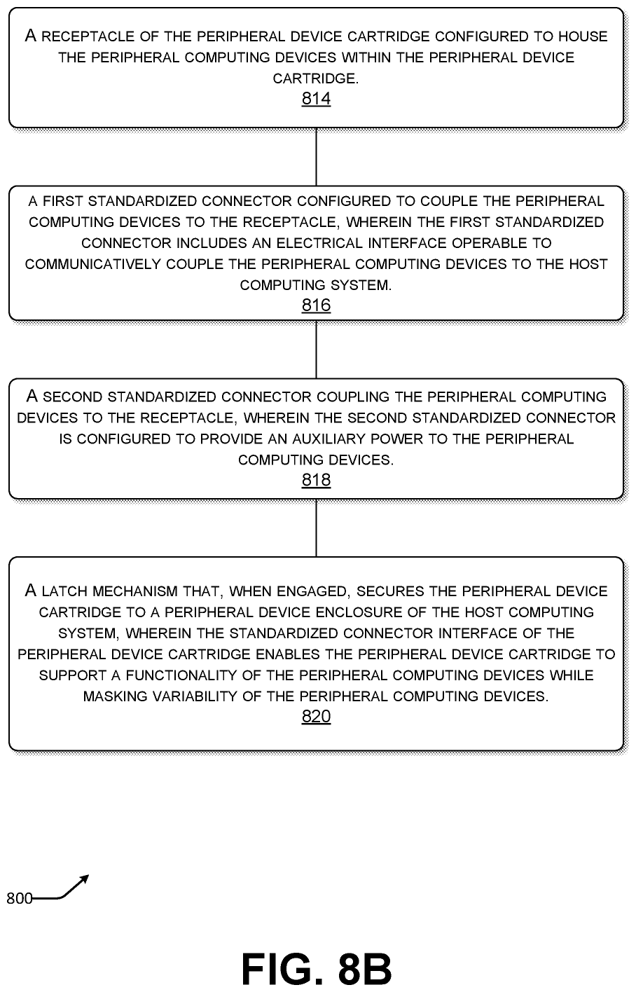

Turning now to FIG. 8A, aspects of a routine 800 for implementing a server device comprising a host computing system and a peripheral device cartridge are shown and described. With respect to FIG. 8A, the routine 800 begins at operation 802 in which a server device is constructed comprising a host computing system configured to interface with one or more peripheral computing devices through a peripheral device cartridge via a standardized connector interface.

Next at operation 804, the server device is configured with a fundamental hardware platform of the host computing system including a motherboard module comprising a central computing unit coupled to a memory system.

Then, at operation 806, the server device is configured with an interface between the fundamental hardware platform and a peripheral device enclosure of the host computing system including a plurality of connection components.

Subsequently, at operation 808, the server device is configured with a power distribution system coupled to the peripheral device enclosure to provide an auxiliary power to the peripheral device enclosure.

Next, at operation 810, the server device is configured with the peripheral device enclosure for housing a plurality of peripheral device cartridges, comprising the standardized connector interface configured to receive the peripheral device cartridge, the standardized connector interface being coupled to the interface between the fundamental hardware platform the peripheral device enclosure.

Then, at operation 812, the server device is configured with a peripheral device cartridge coupled to the peripheral device enclosure.

With reference to FIG. 8B, the routine 800 at operation 814 where the server device is configured with a receptacle of the peripheral device cartridge configured to house the one or more peripheral computing devices within the peripheral device cartridge.

Next, at operation 816, the server device is configured with a first standardized connector between the one or more peripheral computing devices and the receptacle for interfacing the one or more peripheral computing devices to the host computing system.

Then, at operation 818, the server device is configured with a second standardized connector between the one or more peripheral computing devices and the receptacle for providing an auxiliary power to the one or more peripheral computing devices.

Finally, at operation 820, the server device is configured with a latch mechanism that, when engaged, secures the peripheral device cartridge to a peripheral device enclosure of the host computing system, wherein the standardized connector interface of the peripheral device cartridge masks a variability of the one or more peripheral computing devices.

For ease of understanding, the processes discussed in this disclosure are delineated as separate operations represented as independent blocks. However, these separately delineated operations should not be construed as necessarily order dependent in their performance. The order in which the process is described is not intended to be construed as a limitation, and any number of the described process blocks may be combined in any order to implement the process or an alternate process. Moreover, it is also possible that one or more of the provided operations is modified or omitted.

The particular implementation of the technologies disclosed herein is a matter of choice dependent on the performance and other requirements of a computing device. Accordingly, the logical operations described herein are referred to variously as states, operations, structural devices, acts, or modules. These states, operations, structural devices, acts, and modules can be implemented in hardware, software, firmware, in special-purpose digital logic, and any combination thereof. It should be appreciated that more or fewer operations can be performed than shown in the figures and described herein. These operations can also be performed in a different order than those described herein.

It also should be understood that the illustrated methods can end at any time and need not be performed in their entireties. Some or all operations of the methods, and/or substantially equivalent operations, can be performed by execution of computer-readable instructions included on a computer-storage media, as defined below. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

For example, the operations of the routine 600, 700, and/or 800 can be implemented, at least in part, by modules running the features disclosed herein can be a dynamically linked library (DLL), a statically linked library, functionality produced by an application programing interface (API), a compiled program, an interpreted program, a script, or any other executable set of instructions. Data can be stored in a data structure in one or more memory components. Data can be retrieved from the data structure by addressing links or references to the data structure.

Although the illustration may refer to the components of the figures, it should be appreciated that the operations of the routine 600, 700, and/or 800 may be also implemented in other ways. In addition, one or more of the operations of the routine 600, 700, and/or 800 may alternatively or additionally be implemented, at least in part, by a chipset working alone or in conjunction with other software modules. In the example described below, one or more modules of a computing system can receive and/or process the data disclosed herein. Any service, circuit, or application suitable for providing the techniques disclosed herein can be used in operations described herein.

The disclosure presented herein also encompasses the subject matter set forth in the following clauses.

Example Clause A, a peripheral device cartridge configured to interface one or more peripheral computing devices to a host computing system through a standardized connector interface, the peripheral device cartridge comprising: a receptacle configured to house the one or more peripheral computing devices within the peripheral device cartridge; a first standardized connector configured to couple the one or more peripheral computing devices to the receptacle, wherein the first standardized connector includes an electrical interface operable to communicatively couple the one or more peripheral computing devices to the host computing system; a second standardized connector configured to provide an auxiliary power to the one or more peripheral computing devices; and a latch mechanism that, when engaged, secures the peripheral device cartridge to a peripheral device enclosure of the host computing system, wherein the standardized connector interface of the peripheral device cartridge enables the peripheral device cartridge to support a functionality of the one or more peripheral computing devices while masking variability of the one or more peripheral computing devices.

Example Clause B, the peripheral device cartridge of Example Clause A, wherein the peripheral device cartridge comprises a form factor configured to house two or more interconnected peripheral computing devices.

Example Clause C, the peripheral device cartridge of Example Clause A, wherein the peripheral device cartridge comprises a form factor configured to house a single peripheral computing device.

Example Clause D, the peripheral device cartridge of any one of Example Clause A through Example Clause C, wherein the one or more peripheral computing devices are configured to support a task of the host computing system.

Example Clause E, the peripheral device cartridge of any one of Example Clause A through Example Clause D, further comprising a light-emitting device configured to indicate a current status of the one or more peripheral computing devices.

Example Clause F, the peripheral device cartridge of any one of Example Clause A through Example Clause E, wherein the auxiliary power matches a power requirement of the one or more peripheral computing devices.

Example Clause G, the peripheral device cartridge of any one of Example Clause A through Example Clause F, wherein the latch mechanism further prevents a removal of the peripheral computing device when engaged.

Example Clause H, a host computing system configured to interface with one or more peripheral computing devices through a peripheral device cartridge via a standardized connector interface comprising: a fundamental hardware platform including a motherboard module comprising a central computing unit coupled to a memory system; an interface between the fundamental hardware platform and a peripheral device enclosure including a plurality of connection components; a power distribution system coupled to the peripheral device enclosure, wherein the power distribution system is configured to provide an auxiliary power to the peripheral device enclosure; and the peripheral device enclosure configured to house a plurality of peripheral device cartridges, comprising the standardized connector interface configured to receive the peripheral device cartridge, the standardized connector interface being coupled to the interface between the fundamental hardware platform the peripheral device enclosure, wherein the standardized connector interface of the peripheral device cartridge enables the peripheral device cartridge to support a functionality of the one or more peripheral computing devices while masking variability of the one or more peripheral computing devices.

Example Clause I, the host computing system of Example Clause H, wherein one or more peripheral device cartridges of the plurality of peripheral device cartridges is removed from the peripheral device enclosure without disrupting a power provided to the host computing system.

Example Clause J, the host computing system of Example Clause H or Example Clause I, wherein one or more peripheral device cartridges of the plurality of peripheral device cartridges is removed from the peripheral device enclosure without disrupting a software service executed by the host computing system.

Example Clause K, the host computing system of any one of Example Clause H through Example Clause J, wherein the plurality of peripheral device cartridges comprises individual peripheral device cartridges having a fixed size.

Example Clause L, the host computing system of any one of Example Clause H Example Clause J, wherein the plurality of peripheral device cartridges comprises individual peripheral device cartridges having a variable size.

Example Clause M, the host computing system of any one of Example Clause H through Example Clause L, wherein the power distribution system modifies the auxiliary power based on a power requirement of the plurality of peripheral device cartridges.

Example Clause M, the host computing system of any one of Example Clause H through Example Clause M, wherein the peripheral device enclosure includes an intrusion detection device that, when engaged, prevents a removal of the plurality of peripheral device cartridges.

Example Clause O, a server device comprising: a host computing system configured to interface with one or more peripheral computing devices through a peripheral device cartridge via a standardized connector interface; a fundamental hardware platform of the host computing system including a motherboard module comprising a central computing unit coupled to a memory system; an interface between the fundamental hardware platform and a peripheral device enclosure of the host computing system including a plurality of connection components; a power distribution system coupled to the peripheral device enclosure, wherein the power distribution system is configured to provide an auxiliary power to the peripheral device enclosure; the peripheral device enclosure configured to house a plurality of peripheral device cartridges, comprising the standardized connector interface configured to receive the peripheral device cartridge, the standardized connector interface being coupled to the interface between the fundamental hardware platform the peripheral device enclosure; a peripheral device cartridge coupled to the peripheral device enclosure; a receptacle of the peripheral device cartridge configured to house the one or more peripheral computing devices within the peripheral device cartridge; a first standardized connector configured to couple the one or more peripheral computing devices to the receptacle, wherein the first standardized connector includes an electrical interface operable to communicatively couple the one or more peripheral computing devices to the host computing system; a second standardized connector coupling the one or more peripheral computing devices to the receptacle, wherein the second standardized connector is configured to provide an auxiliary power to the one or more peripheral computing devices; and a latch mechanism that, when engaged, secures the peripheral device cartridge to a peripheral device enclosure of the host computing system, wherein the standardized connector interface of the peripheral device cartridge enables the peripheral device cartridge to support a functionality of the one or more peripheral computing devices while masking variability of the one or more peripheral computing devices.

Example Clause P, the server device of Example Clause O, wherein one or more peripheral device cartridges of the plurality of peripheral device cartridges is removed from the peripheral device enclosure without disrupting a power provided to the host computing system.

Example Clause Q, the server device of Example Clause O or Example Clause P, wherein the peripheral device cartridge comprises a form factor configured to house two or more interconnected peripheral computing devices.

Example Clause R, the server device of any one of Example Clause O through Example Clause Q, wherein the fundamental hardware platform includes a cooling system.

Example Clause S, the server device of any one of Example Clause O through Example Clause R, wherein the fundamental hardware platform includes a control module executing an administrative function for the server device.

Example Clause T, the server device of any one of Example Clause O through Example Clause S, wherein the server device further comprises a third standardized connection between a liquid manifold and the peripheral device cartridge.

Conditional language such as, among others, “can,” “could,” “might” or “may,” unless specifically stated otherwise, are understood within the context to present that certain examples include, while other examples do not include, certain features, elements and/or steps. Thus, such conditional language is not generally intended to imply that certain features, elements and/or steps are in any way required for one or more examples or that one or more examples necessarily include logic for deciding, with or without user input or prompting, whether certain features, elements and/or steps are included or are to be performed in any particular example. Conjunctive language such as the phrase “at least one of X, Y or Z,” unless specifically stated otherwise, is to be understood to present that an item, term, etc. may be either X, Y, or Z, or a combination thereof.

The terms “a,” “an,” “the” and similar referents used in the context of describing the invention (especially in the context of the following claims) are to be construed to cover both the singular and the plural unless otherwise indicated herein or clearly contradicted by context. The terms “based on,” “based upon,” and similar referents are to be construed as meaning “based at least in part” which includes being “based in part” and “based in whole” unless otherwise indicated or clearly contradicted by context.

In addition, any reference to “first,” “second,” etc. elements within the Summary and/or Detailed Description is not intended to and should not be construed to necessarily correspond to any reference of “first,” “second,” etc. elements of the claims. Rather, any use of “first” and “second” within the Summary, Detailed Description, and/or claims may be used to distinguish between two different instances of the same element (e.g., two different peripheral device cartridges).

In closing, although the various configurations have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

It is claimed:

1. A peripheral device cartridge configured to interface one or more peripheral computing devices to a host computing system through a standardized connector interface, the peripheral device cartridge comprising:
a receptacle configured to house the one or more peripheral computing devices within the peripheral device cartridge;
a first standardized connector configured to couple the one or more peripheral computing devices to the receptacle, wherein the first standardized connector includes an electrical interface operable to communicatively couple the one or more peripheral computing devices to the host computing system;
a second standardized connector configured to provide an auxiliary power to the one or more peripheral computing devices; and
a latch mechanism that, when engaged, secures the peripheral device cartridge to a peripheral device enclosure of the host computing system, wherein the standardized connector interface of the peripheral device cartridge enables the peripheral device cartridge to support a functionality of the one or more peripheral computing devices while masking variability of the one or more peripheral computing devices.

2. The peripheral device cartridge of claim 1, wherein the peripheral device cartridge comprises a form factor configured to house two or more interconnected peripheral computing devices.

3. The peripheral device cartridge of claim 1, wherein the peripheral device cartridge comprises a form factor configured to house a single peripheral computing device.

4. The peripheral device cartridge of claim 1, wherein the one or more peripheral computing devices are configured to support a task of the host computing system.

5. The peripheral device cartridge of claim 1, further comprising a light-emitting device configured to indicate a current status of the one or more peripheral computing devices.

6. The peripheral device cartridge of claim 1, wherein the auxiliary power matches a power requirement of the one or more peripheral computing devices.

7. The peripheral device cartridge of claim 1, wherein the latch mechanism further prevents a removal of the peripheral computing device when engaged.

8. A host computing system configured to interface with one or more peripheral computing devices through a peripheral device cartridge via a standardized connector interface, the host computing system comprising:
a fundamental hardware platform including a motherboard module comprising a central computing unit coupled to a memory system;
an interface between the fundamental hardware platform and a peripheral device enclosure including a plurality of connection components;
a power distribution system coupled to the peripheral device enclosure, wherein the power distribution system is configured to provide an auxiliary power to the peripheral device enclosure; and
the peripheral device enclosure configured to house a plurality of peripheral device cartridges, comprising the standardized connector interface configured to receive the peripheral device cartridge, the standardized connector interface being coupled to the interface between the fundamental hardware platform the peripheral device enclosure, wherein the standardized connector interface of the peripheral device cartridge enables the peripheral device cartridge to support a functionality of the one or more peripheral computing devices while masking variability of the one or more peripheral computing devices.

9. The host computing system of claim 8, wherein one or more peripheral device cartridges of the plurality of peripheral device cartridges is removed from the peripheral device enclosure without disrupting a power provided to the host computing system.

10. The host computing system of claim 8, wherein one or more peripheral device cartridges of the plurality of peripheral device cartridges is removed from the peripheral device enclosure without disrupting a software service executed by the host computing system.

11. The host computing system of claim 8, wherein the plurality of peripheral device cartridges comprises individual peripheral device cartridges having a fixed size.

12. The host computing system of claim 8, wherein the plurality of peripheral device cartridges comprises individual peripheral device cartridges having a variable size.

13. The host computing system of claim 8, wherein the power distribution system configures the auxiliary power to match a power requirement of the plurality of peripheral device cartridges.

14. The host computing system of claim 8, wherein the peripheral device enclosure includes an intrusion detection device that, when engaged, prevents a removal of the plurality of peripheral device cartridges.

15. A server device comprising:
a host computing system configured to interface with one or more peripheral computing devices through a peripheral device cartridge via a standardized connector interface;
a fundamental hardware platform of the host computing system including a motherboard module comprising a central computing unit coupled to a memory system;
an interface between the fundamental hardware platform and a peripheral device enclosure of the host computing system including a plurality of connection components;
a power distribution system coupled to the peripheral device enclosure, wherein the power distribution system is configured to provide an auxiliary power to the peripheral device enclosure;
the peripheral device enclosure configured to house a plurality of peripheral device cartridges, comprising the standardized connector interface configured to receive the peripheral device cartridge, the standardized connector interface being coupled to the interface between the fundamental hardware platform the peripheral device enclosure;
a peripheral device cartridge coupled to the peripheral device enclosure;
a receptacle of the peripheral device cartridge configured to house the one or more peripheral computing devices within the peripheral device cartridge;
a first standardized connector configured to couple the one or more peripheral computing devices to the receptacle, wherein the first standardized connector includes an electrical interface operable to communicatively couple the one or more peripheral computing devices to the host computing system;
a second standardized connector coupling the one or more peripheral computing devices to the receptacle, wherein the second standardized connector is configured to provide an auxiliary power to the one or more peripheral computing devices; and
a latch mechanism that, when engaged, secures the peripheral device cartridge to a peripheral device enclosure of the host computing system, wherein the standardized connector interface of the peripheral device cartridge enables the peripheral device cartridge to support a functionality of the one or more peripheral computing devices while masking variability of the one or more peripheral computing devices.

16. The server device of claim 15, wherein one or more peripheral device cartridges of the plurality of peripheral device cartridges is removed from the peripheral device enclosure without disrupting a power provided to the host computing system.

17. The server device of claim 15, wherein the peripheral device cartridge comprises a form factor configured to house two or more interconnected peripheral computing devices.

18. The server device of claim 15, wherein the fundamental hardware platform includes a cooling system.

19. The server device of claim 15, wherein the fundamental hardware platform includes a control module executing an administrative function for the server device.

20. The server device of claim 15, wherein the server device further comprises a third standardized connection between a liquid manifold and the peripheral device cartridge.
